(19) United States
(12) Patent Application Publication
(10) Pub. No.: US 2006/0047770 A1
(43) Pub. Date: Mar. 2, 2006

(54) Direct information copy and transfer between real-time messaging applications

(75) Inventors: Kumar Marappan, Round Rock, TX (US); Kanmani Nachimuthu, Austin, TX (US); Lakshmi Potluri, Austin, TX (US)

Correspondence Address: Robert H. Frantz, P.O. Box 23324, Oklahoma City, OK, 73123, US

(73) Assignee: International Business Machines Corporation, Armonk, NY (US)

(21) Appl. No.: 10/932,753

(22) Filed: Sep. 2, 2004

(51) Int. Cl. G06F 15/16

(52) U.S. Cl. 709/207

(57) ABSTRACT

Information transfer between instant messaging applications and configured personal information management application programs such as electronic address books, date books, phone books, to do list, and the like, is automated to alleviate burdensome and tedious user actions of manually cutting and pasting several strings of text from the instant messaging user interface and the user interface for the personal information management application program. Upon invocation, such as by highlighting text in the messaging window and right-clicking it, an action menu is displayed. The user selects an action, such as “add to calendar”, and an intermediate menu is displayed for the user to select a field to which the highlighted text applies, such as “date”. After a series of quick selections and designations, the system completes the action using the application programming interface for the appropriate PIM application program.

### CROSS-REFERENCE TO RELATED APPLICATIONS (CLAIMING BENEFIT UNDER 35 U.S.C. 120)

None.

### CROSS-REFERENCE TO RELATED APPLICATIONS

None.

### FEDERALLY SPONSORED RESEARCH AND DEVELOPMENT STATEMENT

This invention was not developed in conjunction with any Federally-sponsored contract.

### MICROFICHE APPENDIX

Not applicable.

### INCORPORATION BY REFERENCE

None.

### BACKGROUND OF THE INVENTION

1. Field of the Invention

This invention relates to direct information copy and transfer between real-time messaging applications and corresponding applications.

2. Background of the Invention

Communication methods have grown in the number of mediums employed, as well as through various approaches to conduct and interconnect one party with another. One popular method that even corporations allow its employees to use is referred to as “Instant Messaging”, or “IM”. IM is a program that helps people work together collectively while they are located remotely from each other. IM has the ability to allow one user to see whether a chosen friend or colleague is simultaneously connected to the Internet, and if they are, to exchange messages with them.

IM differs greatly from ordinary electronic mail (“e-mail”) in its immediacy of message exchange, and in its ability to determine if certain other users (e.g. “buddies”) are currently online. In addition, the continuous exchange between two-parties are simpler than sending e-mail back and forth. Most IM exchanges are text-only, with additional features such as sharing of Web links, images, sounds, streaming content, voice messaging and files provided.

Because IM includes “presence technology,” when a user launches their IM application, it allows the ability to see which other users on their contact list are currently online. In order for instant messaging to work, both users must subscribe to the same service, be online at the same time, the initiator and the receiver must allow participation from one another, and both must be willing to participate in accepting instant messages.

Attempts to send an instant message to someone who is not online, where their participation status is not available, or when the intended recipient refuses the invitation to add the sending party to their own list, result in notification to the sender that the transmission can not be completed.

If a user's IM client software accepts an instant message (e.g. receives a message), it alerts the recipient typically with a distinctive sound, an icon to denote availability status, and a window that indicates that new IM has arrived which provides the recipient with the ability to view the actual incoming message.

Sometimes, a person might receive an instant message from someone who is already engaged in a group chat with someone else. Current IM software has the ability to add additional online users to existing conversations by sending an invitation to the existing group members.

Turning to FIG. 1, the general organization of components and their intercommunications for instant messaging is shown (10). A plurality of messaging clients (14), including individual network clients (15, 16) such as cellular phones, PDAs, and personal computers, communicate via a common computer network, such as the Internet, local area network (“LAN”), or wide area network (“WAN”), to corresponding messaging servers (11, 12, 13).

Under most circumstances, message exchange is “instant” and “immediate.” The delay is rarely more than a few seconds, even during peak Internet usage periods. Thus, instant messaging requires quite a bit less storage for messages as they are not held for any considerable length of time by the messaging server(s).

IM applications are generally categorized as either being public or enterprise. Public IM applications allow anyone on the Internet to sign up, download the software and begin messaging. Microsoft.NET Messenger™, America Online's AIM™ and Yahoo Messenger!™ are examples of public IM software.

On the other hand, enterprise IM services such as IBM Lotus' Instant Messaging and Web Conferencing, formerly called Sametime, and Sun Microsystems' ONE Instant Messaging, are typically used within corporate environment. Access to an enterprise IM server is typically restricted, and security precautions such as encryption are put in place to protect the enterprise network.

With all the different IM applications available, most systems work similarly. Once the user launches the IM application, the messaging client attempts to connect to the messaging server. Authentication occurs on the messaging server to verify information such as username and password. Once verification is successful, the client computer sends the server its network address, a port number that is assigned to the IM service and the names of people from the user's contact list. The server creates a temporary session file that contains the connection information and checks the contact list to see if anyone else also logged onto the system.

Once the server finds the contacts who are online, it sends a message back to the client computer with its connection information and vice versa. The client user interface displays the nicknames or names of the other online users from the contact list. When all connection information has been exchanged and acknowledged, an instant messaging session can begin. This connection process typically takes about ten seconds.

Because of IM's ease of usage and its real-time messaging exchange, people communicate phone numbers, URLs, tasks and appointments using instant messaging applications. In the event the user has to save this information, recipients must manually copy and paste this information into the respective applications for later use. The following are the steps involved in the process. For example, if a first user proposes a meeting, subject, time and place, to a second user, the second user must manually create an appointment with his or her own appointment management software application. Here is a typical process such as this:
(1) the second user receives a message containing a phone number or an URL or a date and time for some event;
(2) the second user opens the relevant application(s), such as his or her phone book or appointment and datebook software;
(3) after the application is opened, the second user selects some text from the IM user interface;
(4) the second user then switches to the relevant application user interface; and
(5) pastes the copied text from the instant message into the relevant form or field of the application.

Because several different items of information often must be transferred separately, such as meeting subject, meeting time, meeting place, and meeting contact, the second user may have to repeat steps 1-5 several times to complete the creation of an appointment in his or her electronic appointment book.

These steps are time consuming for the participants of the IM session, and are also tedious, monotonous, and prone to error. Because of these repetitive steps, some users usually save multiple message files for future reference. This process also distracts the user's flow of thought as the user gets engaged with the process of opening applications, cutting, pasting, and switching between user interfaces.

Therefore, there exists a need in the art for automating the process of transferring information from an instant messaging user interface to one or more personal ion management (“PIM”) applications.

### BRIEF DESCRIPTION OF THE DRAWINGS

The following detailed description when taken in conjunction with the figures presented herein present a complete description of the present invention.

FIG. 1 illustrates instant messaging from a high level.

FIG. 2 shows IBM's Sametime Server architecture structure.

FIG. 3 depicts IBM's Sametime community in a schematic view.

FIG. 4 shows how conversations are established via channels for one messaging server.

FIG. 5 illustrates inter-communication between multiple messaging servers.

FIG. 6 illustrates a logical process according to the present invention of invoking the present invention from an instant messaging user interface.

FIG. 7 depicts a logical process according to the present invention for text transfer from a messaging application to a selected PIM application.

FIGS. 8 through 12 illustrate portions of a user display during operation of the invention.

FIG. 13 shows a portion of a user display having a confirmation dialog.

FIG. 14 illustrates the overall information flow of the present invention in association with one or more Personal Information Messenger (“PIM”) applications and an instant messaging application.

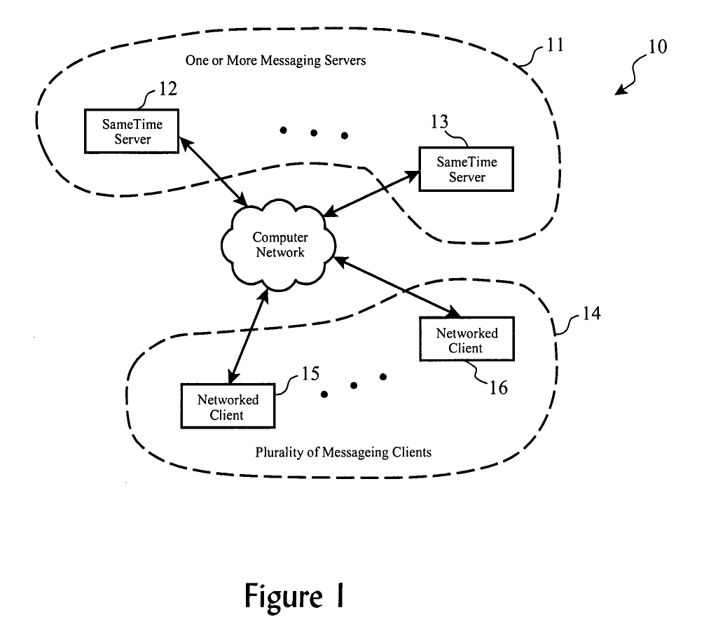

### SUMMARY OF THE INVENTION

The present invention provides instant messaging users the ability to automate information transfer between messaging applications and configured personal information management application programs such as electronic address books, date books, phone books, to do list, and the like. Our invention provides user-configurable options to specify which related application programs should automatically store the selected text from messaging applications.

Automating the information transfer between the related applications and messaging applications in this manner reduces the overall time spent by the user to transfer information to PIM application, the number of repetitive steps and thus user fatigue, and minimizes distraction in user flow of thoughts as messaging exchanges take place.

### DETAILED DESCRIPTION OF THE INVENTION

With all the different messaging applications available, most systems work similarly. IBM's Sametime messaging system will be used to illustrate present invention in one available embodiment, but it will be recognized by those skilled in the art that other instant messaging applications and platforms can be used for realization of the present invention.

Instant Messaging Architecture as a Platform for the Invention

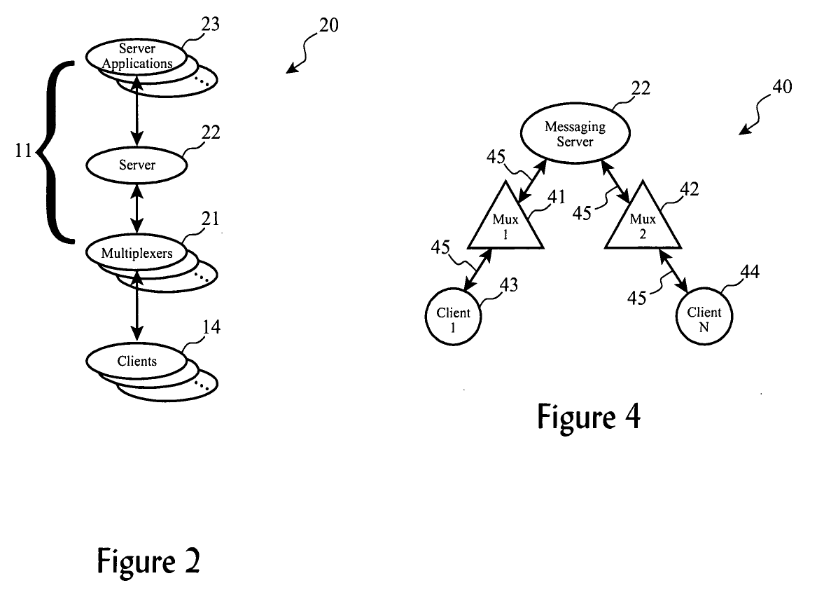

Turning to FIG. 2, the IBM's Sametime Server architecture (20) is shown. A community is defined as a collection of servers, either in distributed WAN or scalable LAN environment. The Clients (14) are the client-side programs that log into the community as a community user via the multiplexers (21), which mediate between the clients and a server. The messaging server (22) is the core server of the messaging community, and server applications (23) supply add-on services to the community.

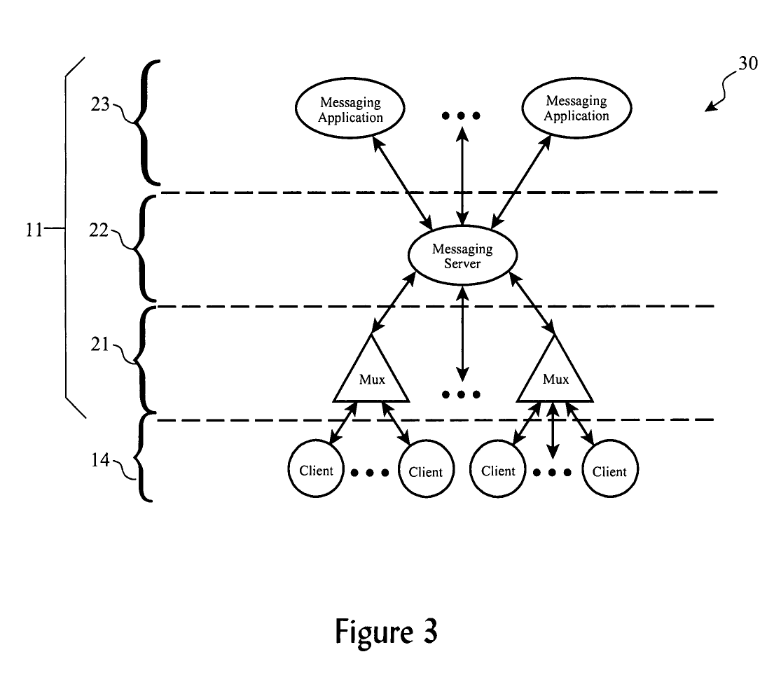

IBM's Sametime community schematic view (30) is depicted in FIG. 3. The clients (14) communicate via the Multiplexers (21). The multiplexers enable highly efficient and scalable operation through I/O concentration, distribution of multi-recipient messages, and performance of gateway functions. This concentration limits the I/O overhead of the server because the server is required to send and receive data on a small number of connections to the multiplexers. The server is able to send a single copy of a message with its recipient list attached to its multiplexer, and the multiplexer then distributes the message to the indicated recipients.

Because a multiplexer can act as a gateway, it is able to translate protocols between clients or third-party client software and Sametime server. For instance, an extended hypertext transfer protocol (“HTTP”) multiplexer that allows clients to work with the Sametime community using the HTTP protocol acts as a security firewall and protocol converter so that a user can use a web browser as their client software into the Sametime system.

Thus, by acting as a gateway, the multiplexer can allow integration of different protocols while enabling the Sametime server to continue and use the Sametime optimized protocol. The multiplexer layer is transparent to the clients that connect to the messaging community through them. Multiplexers can connect in a multi-level fashion where a multiplexer is not directly connected to the server, but instead connects to another multiplexer in a chain of multiplexers. Layering can be used for localizing user connections and/or in a firewalled environment where the multiplexer acts as a proxy.

The messaging server (22) that is the core of the Sametime community is responsible for managing the community members such as users, logins, multiplexers and server applications, routing messages, and supplying notifications to its community members.

The messaging server applications (23) extend and customize the functionality supplied by the server. A server application connects to a server and declares the services it is supplying. The server routes requests for such services to the appropriate instance of the server applications. Some of the services supplied by native Sametime server applications include using buddy list, authenticating of users to its servers, matching user name with user identifications, browsing and searching capability via a directory, and supplying chat rooms for user participation. Third-party vendors using the Server toolkit are able to develop other customized services. For example, a Sametime IM system deployed within an investment company's enterprise may provide for custom instant messaging functions including real-time stock quotes or economic data retrieval.

Instant Messaging Channels

The diagram of FIG. 4 shows (40) how conversations are established via channels (45) between a messaging server (22) and two or more specific clients (43). Channels are virtual connections that route messages. A channel may span several Transmission Control Protocol/Internet Protocol (“TCP/IP”) connections. In this example, Client 1 (43) on Multiplexer 1 (41) initiates a message exchange which creates a channel (45) to a messaging server (22) that travels to the corresponding Multiplexer 2 (42) for Client 2 (44).

The network route between any community members may involve several “hops” between components. The channel ensures the order of messages is maintained during a conversation, and ensures connectivity by providing a notification when the route of the channel is broken (e.g., when a crash occurs on one of the parties or on one of the community members along the channel route). Both channel participants receive a notification when the channel is broken. Data that enables routing of channel messages is stored in each of the community entities of the channel route.

Larger Instant Messaging Communities

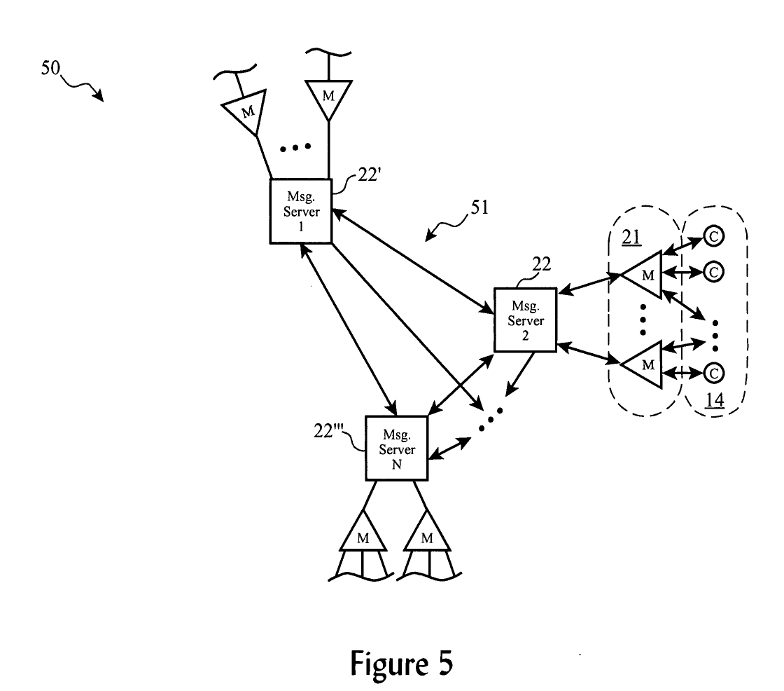

Additionally, multiple messaging servers can communicate with each other to form larger communities, and to interface enterprise-only communities to clients and users in the public domain. FIG. 5 illustrates the inter-communication (51) between multiple messaging servers in such an extended arrangement (50). Each messaging server (22, 22′, 22′″) has its related multiplexers and clients, and each uses appropriate protocols such as TCP/IP, HTTP, Simple Mail Transfer Protocol (“SMTP”) and Simple Object Access Protocol (“SOAP”) to inter-communicate (51) with each other and allow messaging exchange.

Integration to PIM Applications

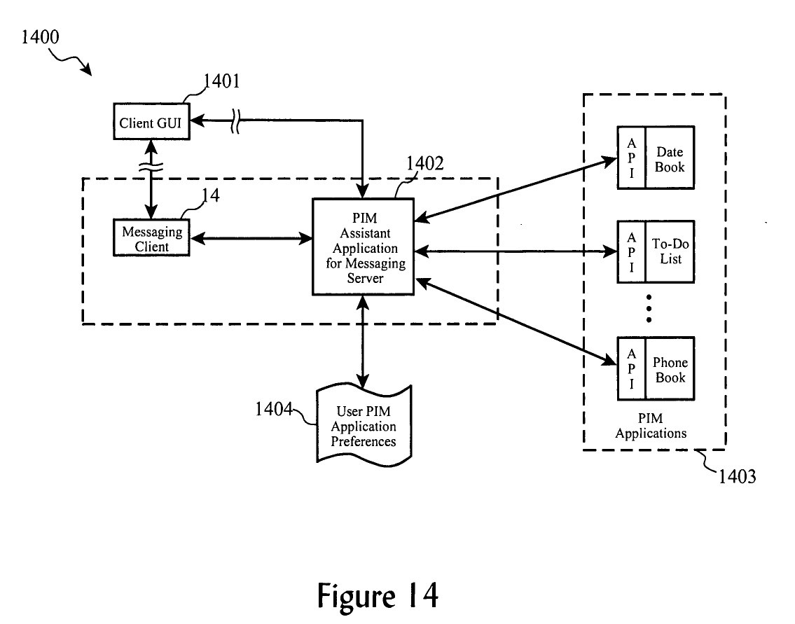

FIG. 14 illustrates the overall information flow via Personal Information Messenger (“PIM”) applications (1403) via their Application Programming Interface (“APIs”), and the messaging client (14), according to the present invention, when enables automated information transfer from instant messages to PIM applications via our PIM Assistant (1402).

The messaging client (14) integrates to and communicates with the PIM Assistant Application for Messaging Client (1402). Both are capable of presenting menus, forms, and prompts on the client Graphical User Interface (“GUI”) (1401). Presently, most IM clients are not extendable through dynamic link libraries (“DLLs”) or plug-ins, so our method of embodying the PIM Assistant (1402) is to provide integral software to the messaging client itself. However, as messaging clients become more flexible and potentially standardized, it is conceivable that implementation as a plug-in, DLL or other extensible module will be possible (and within the scope of the present invention).

When the user invokes the present invention, user configured PIM Application Preferences (1404) are accessed to allow the PIM Assistant (1402) to determine which default applications are to be used to store selected text from instant messages. This allows highlighted text data to be transferred via the appropriate API to corresponding PIM applications (1403) as selected by the user, including all required specific fields related to the functionality of each PIM application (1403).

Logical Processes and Use of the Invention

The IM client including the present invention allows the selection of a piece of text from anywhere within the chat window session. Then, the user can right click on the selected text (or otherwise specially select the text), and a pop-up menu provides options such as “Add to Phone Book”, “Add to Favorites”, “Add to Tasks”, and “Add to Calendar”. The preferred method to invoke the invention is a right click, but those skilled in the art will recognize that it can be any combination of buttons, tapping on a PDA, or any other invoking method.

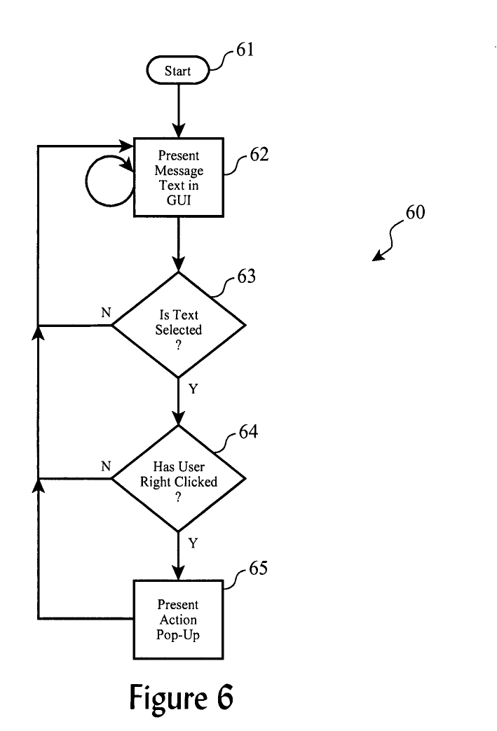

FIG. 6 illustrates a logical process (60) according to the invention of invoking (61) the invention from the IM user interface. The IM application is previously running, and a channel is already established, and one or more text messages are shown (62) in graphical user interface (“GUI”).

When an user selects a text to be saved, the system checks to see if text is specially selected (63). If text is not selected, then conversation continues normally in the GUI (62). If the highlighted text is specially selected, the system verifies the special selection feature (64), and the PIM assistant popup menu is displayed (65).

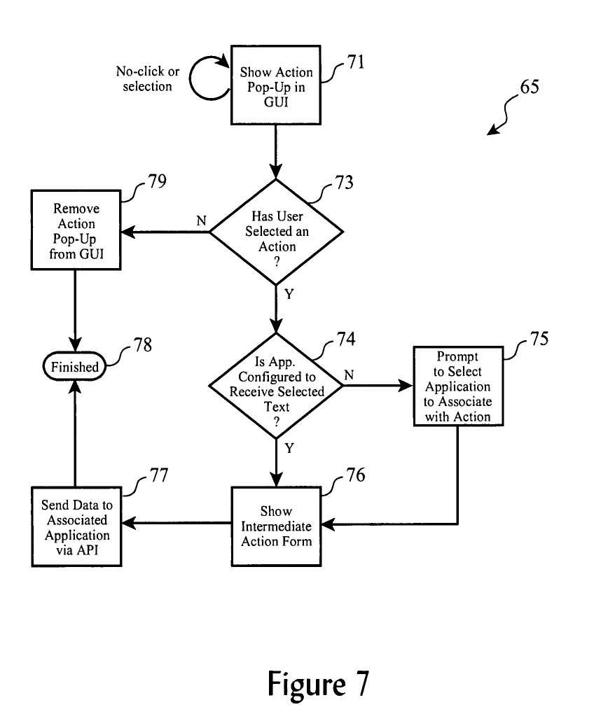

Following display of the PIM assistant popup menu, then a logical process (65) according to the invention such as that shown in FIG. 7 is executed. This logical process first presents a list of “actions”, such as “Add to Address Book” or “Add to Appointment Calendar” (75), followed by displaying an appropriate intermediate action form (76) depending on the actions selected (73).

If the action selected does not currently have a PIM application designated for receiving the information in the user's preferences, the user is prompted (75) to select or indicate a PIM application to receive the information from the action, according to the preferred embodiment.

Once the information from the text message has been transferred to the intermediate form, the invention then operates (77) the designated PIM application's API to complete the action, and the action is finished (78).

If the user fails to select an action (73), then the action and/or intermediate form pop-ups are removed (79) from the user interface display.

Examples of Operation of the Invention

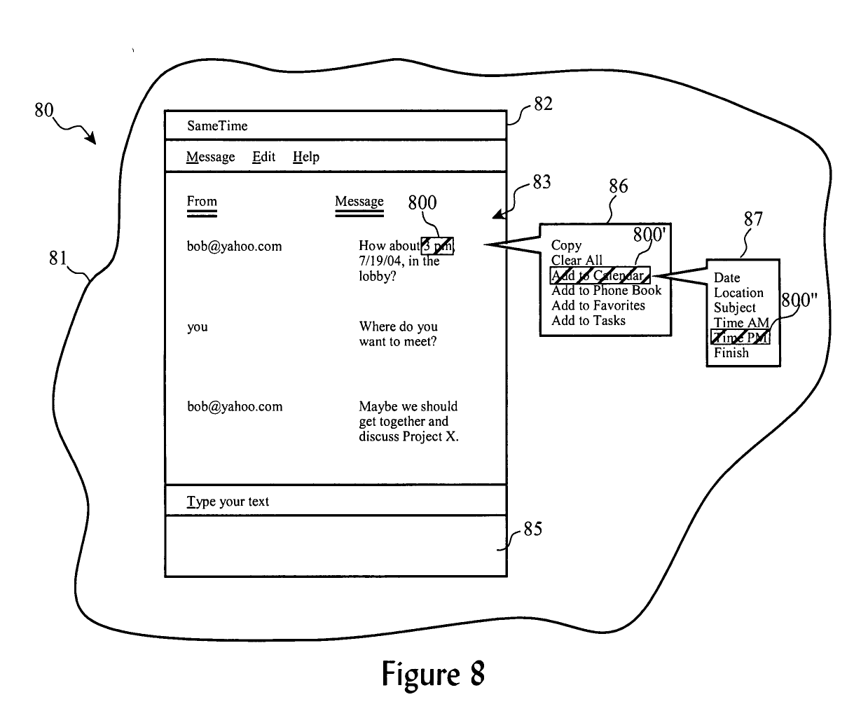

Turning to FIG. 8, a portion of an user display (80) includes a display of an example instant messaging user interface (82). In this example, a thread of discussion between two users includes several messages (83), which are in sequence discussing a possible meeting. Messages that have been sent and received are displayed in one section of the client UI (83), and the local user can input new a text message in the editor section (85).

In this example, enough messages have been exchanged for the local user (“you”) and the remote user, Bob, to establish a new meeting appointment. The local user wishes to add this appointment to his or her electronic appointment book or calendar, such as their local copy of Lotus Organizer™ or Palm Desktop™.

First, the user highlights “3 pm” (800) and right clicks to invoke the present invention. An action popup menu (86) is displayed which shows the various actions the user may select to perform on the highlighted text, such as Copy, Add to Calendar, Add to Phone Book, Add to Favorites and Add to Tasks. If Copy option is chosen, then the highlighted text will be copied into a buffer or a system clipboard.

However, if the user wishes to create a new appointment in his datebook PIM, the Add to Calendar (800′) option is selected, and an intermediate popup menu (87) associated with Add to Calendar option is then shown on the GUI by the invention. In so doing, the invention consults the user's preferences and/or the API for the associated PIM application, and displays a list of “fields” or data items which are available for a new appointment in this case.

The user may now choose which field to which the selected information should be transferred, such as Date, Location, Subject, Time AM, Time PM, or Contact. In this scenario, “Time PM” (800″) is selected by the user as he or she has highlighted the appointment time in the message. The selected text is then associated with the selected field, and temporarily saved until the user selects the “Finish” sub-action.

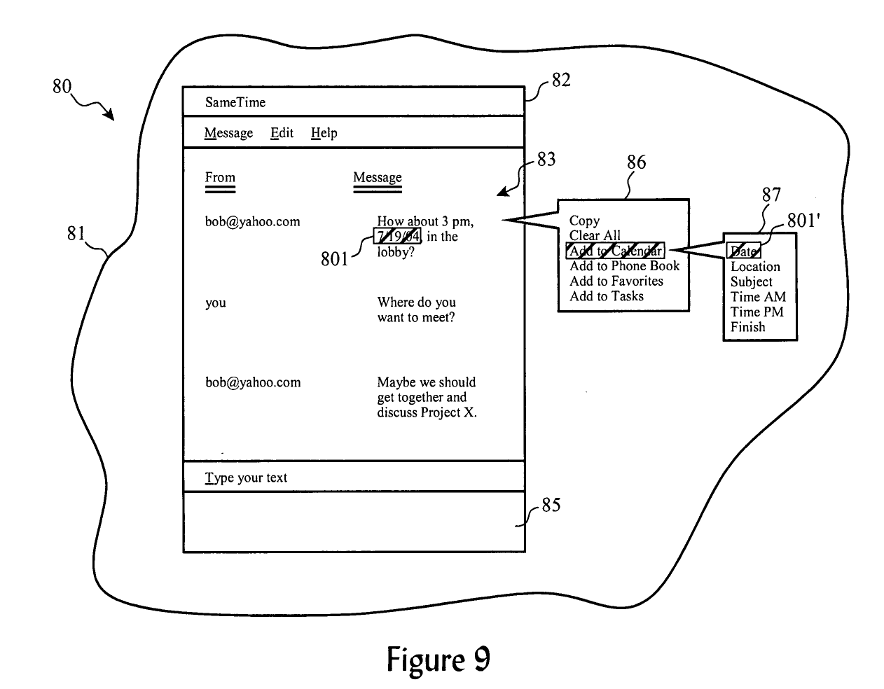

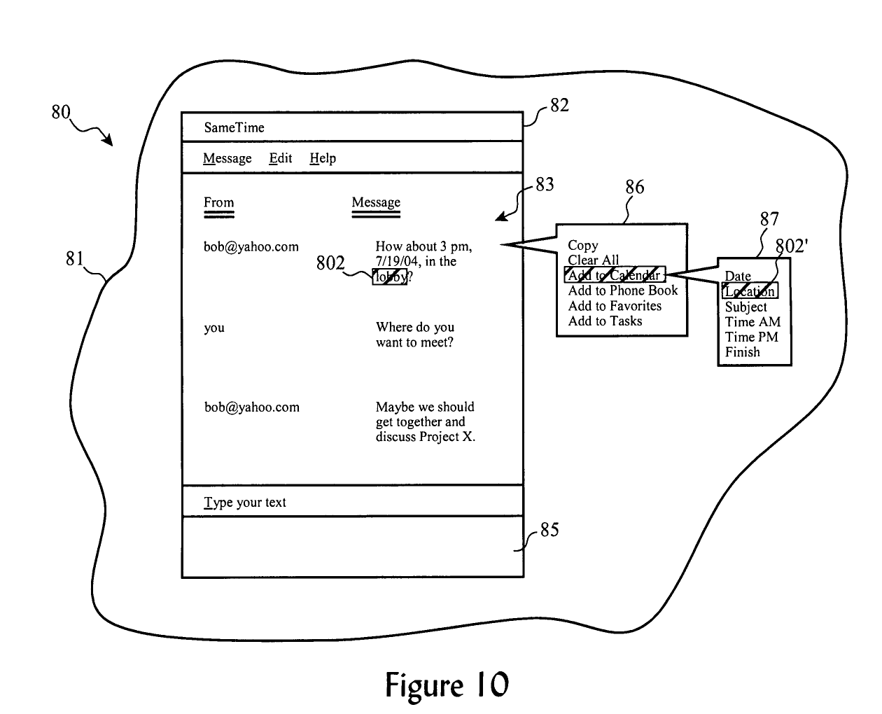

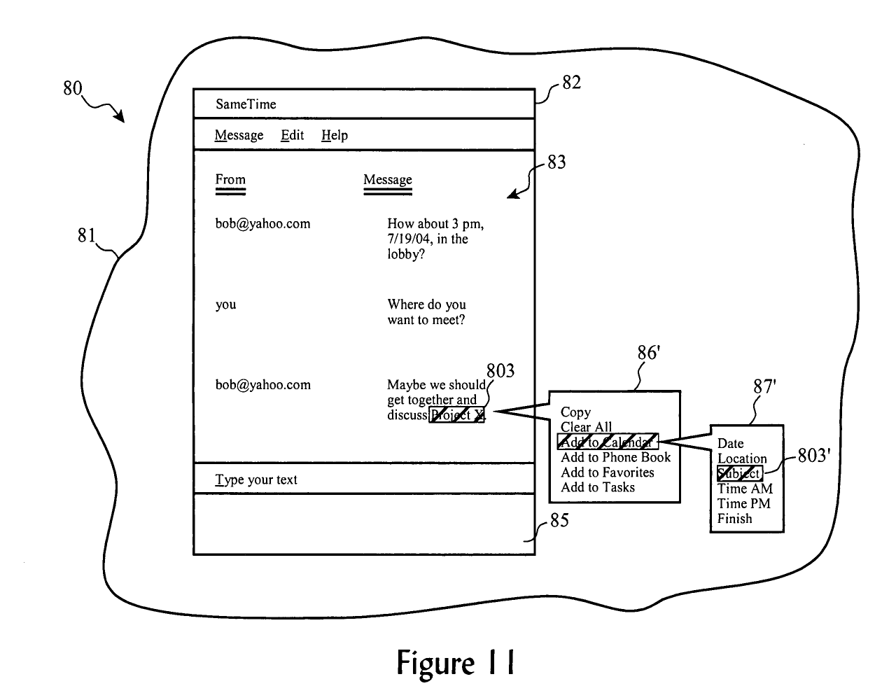

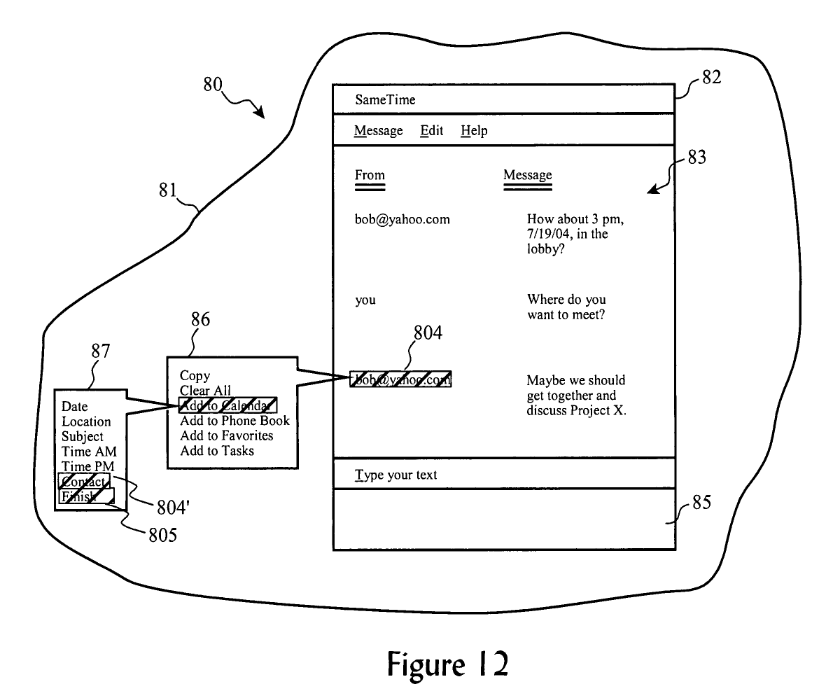

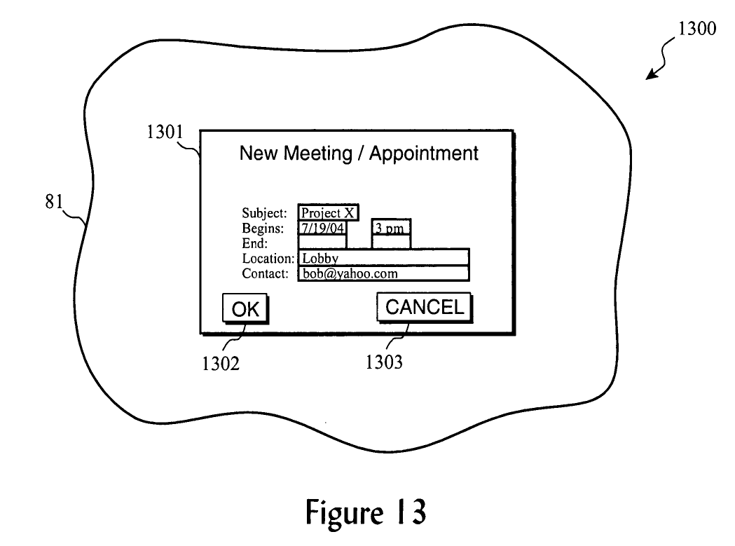

The user may now continue to select text in the messaging window, and then to indicate to which field the information applies, such as:
(a) highlighting “Jul. 19, 2004” (801) from the messaging window (FIG. 9);
(b) selecting “Date” (801′) in the intermediate menu;
(c) highlighting “lobby” (802) from the messaging window (FIG. 10;
(d) selecting is save to the default calendar application field for location (802′);
(e) highlighting “Project X” (803) from the messaging window (FIG. 11);
(f) selecting “Subject” (803′) in the intermediate menu;
(g) highlighting “bob@yahoo.com” (804) from the messaging window (FIG. 12); and
(h) selecting “Contact” (804′) in the intermediate menu.

At this point, the invention has accumulated the following information associated with the new calendar item:
time=3 pm
date=Jul. 19, 2004
location=lobby
subject=Project X
contact=bob@yahoo.com

In this example, the user is ready to create the appointment in his or her calendar PIM program, so “Finish” (805) is selected, which then leads (1300) to a confirmation dialog (1301) being shown by the invention on the client display (81), according to the preferred embodiment. This confirmation dialog recaps the information as collected by the invention, and allows the user to correct, edit, or supplement the information. The user can then select to create (1302) the new calendar item, or to abort the operation (1303). If the user selects to create (1302) the new calendar item, the invention operates the appropriate API functions for the configured PIM calendar application program to create a new appointment having the characteristics as defined by the collected information from the IM message(s). It will be recognized by those skilled in the art that alternate realizations of the invention may omit the confirmation dialog (1301) in favor of directly creating the new calendar item upon selection of the “Finish” sub-action by the user.

Other PIM Operations

The invention automates the transfer of information from an IM message to a wide variety of PIM data structures and items, including but not limited to:
(1) Universal Resource Locators and addresses of web pages to a favorites or bookmark list;
(2) contact names, telephone numbers, mailing addresses, and email addresses to a contact manager, phone book or address book; and
(3) tasks including a task description, priority level, due date, task details, etc., to a task manager or “to-do” list.

As such, the scope of the present invention extends beyond the specific embodiment examples and PIM applications presented herein, and should be determined by the following claims.

What is claimed is:

1. A system for transferring information from an instant message to a personal information manager application comprising:
a user transfer invoker operable by a user within an electronic message display;
an action menu displayed to an user responsive to operation of said invoker, said action menu containing one or more user-selectable transfer actions;
an intermediate menu displayed to user responsive to selection of an action from said action menu, said intermediate menu containing one or more user-selectable fields; and
an information transfer assistant configured to populate said action menu with actions, to populate said intermediate menu with said fields, to receive said action and field selections, and to operate an application programming interface for a personal information management (PIM) application program to accomplish said user-selected action with said user-selected fields having information values selected from said electronic message display.

2. The system as set forth in claim 1 further comprising one or more user-configured preferences designating a specific personal information management application to be associated with each action of said action menu.

3. The system as set forth in claim 2 wherein said preferences further comprise one or more field values to be completed in association with each action and each designated PIM application.

4. The system as set forth in claim 1 wherein said transfer actions comprise at least one action from the group of create a calendar item, create a contact card, create a phone book entry, create an address book entry, create task in a task list, and create a favorite address in a favorites list.

5. The system as set forth in claim 1 wherein said fields comprise at least one field from the group of a time indicator, a date indicator, a telephone number, a physical location, a contact name, a mailing address, an email address, a Universal Resource Locator, a network address, and a subject indicator.

6. The system as set forth in claim 1 wherein said information transfer assistant is further configured to produce a confirmation dialog display to said user wherein said user may further define fields prior to completing said action.

7. The system as set forth in claim 1 wherein said invoker is configured to detect a right mouse click user operation within said electronic message display.

8. An automated computer-implemented method for transferring information from an instant message to a personal information manager (PIM) application program, the method comprising the steps of:
invoking a PIM transfer assistant function by a user from a display of an electronic message;
displaying to said user responsive to said invocation an action menu containing one or more user-selectable transfer actions;
responsive to selection of an action from said action menu, displaying an intermediate menu containing one or more user-selectable fields; and
operating an application programming interface for a PIM application program to accomplish said user-selected action with said user-selected fields having information values selected from said electronic message display.

9. The method as set forth in claim 8 further comprising designating a specific personal information management application to be associated with each action of said action menu through recording of one or more user preferences.

10. The method as set forth in claim 9 further comprising designating one or more field values to be completed in association with each action and each designated PIM application.

11. The method as set forth in claim 8 wherein step of displaying an action menu comprises displaying at least one action option from the group of create a calendar item, create a contact card, create a phone book entry, create an address book entry, create task in a task list, and create a favorite address in a favorites list.

12. The method as set forth in claim 8 wherein step of displaying an intermediate menu further comprises displaying at least one field from the group of a time indicator, a date indicator, a telephone number, a physical location, a contact name, a mailing address, an email address, a Universal Resource Locator, a network address, and a subject indicator.

13. The method as set forth in claim 8 further comprising providing a confirmation dialog display to said user wherein said user may further define fields prior to completing said action.

14. The method as set forth in claim 8 wherein step of invocation comprises detecting a right mouse click user operation within said electronic message display.

15. A computer-readable medium encoded with software for transferring information from an instant message to a personal information manager (PIM) application program, the software performing the steps of:
invoking a PIM transfer assistant function by a user from a display of an electronic message;
displaying to said user responsive to said invocation an action menu containing one or more user-selectable transfer actions;
responsive to selection of an action from said action menu, displaying an intermediate menu containing one or more user-selectable fields; and
operating an application programming interface for a PIM application program to accomplish said user-selected action with said user-selected fields having information values selected from said electronic message display.

16. The computer-readable medium as set forth in claim 15 further comprising software for designating a specific personal information management application to be associated with each action of said action menu through recording of one or more user preferences.

17. The computer-readable medium as set forth in claim 16 further comprising software for designating one or more field values to be completed in association with each action and each designated PIM application.

18. The computer-readable medium as set forth in claim 17 wherein software for displaying an action menu comprises software for displaying at least one action option from the group of create a calendar item, create a contact card, create a phone book entry, create an address book entry, create task in a task list, and create a favorite address in a favorites list.

19. The computer-readable medium as set forth in claim 16 wherein software for displaying an intermediate menu further comprises software for displaying at least one field from the group of a time indicator, a date indicator, a telephone number, a physical location, a contact name, a mailing address, an email address, a Universal Resource Locator, a network address, and a subject indicator.

20. The computer-readable medium as set forth in claim 16 further comprising software for providing a confirmation dialog display to said user wherein said user may further define fields prior to completing said action.

21. The computer-readable medium as set forth in claim 16 wherein software for invocation comprises software for detecting a right mouse click user operation within said electronic message display.
